(19) United States
(12) Patent Application Publication
(10) Pub. No.: US 2002/0159407 A1
(43) Pub. Date: Oct. 31, 2002

(54) Method and apparatus for scalable, line-rate protocol-independent switching between multiple remote access points in a wireless local area network

(76) Inventors: Michael W. Carrafiello, Hudson, NH (US); Roger B. Parker, Bolton, MA (US)

Correspondence Address: Chris A. Caseiro, Enterasys Networks, Inc., 50 Minuteman Road, Andover, MA, 01810, US

(21) Appl. No.: 10/134,259

(22) Filed: Apr. 26, 2002

Related U.S. Application Data
(60) Provisional application No. 60/287,501, filed on Apr. 30, 2001.

(51) Int. Cl. H04Q 7/00

(52) U.S. Cl. 370/328; 370/389; 370/401; 370/466

(57) ABSTRACT

The invention is a system and method to uniquely associate remote wireless Access Points using a switch engine. This is necessary in a multi-point wireless network where a central wireless Access Point must be able to receive packets from remote Access Points and then retransmit them, with a modified identifier, back to the wireless port from which they were received. By using available switch engine hardware this invention takes advantage of lower cost, higher performance and increased features in commodity parts. The invention resolves differences in common Ethernet switch engines that make them unsuitable for direct interface to wireless networks such as that defined by IEEE Standard 802.11 by using an aggregated set of physical ports on the switch engine. The method allows the switch engine to operate in its normal manner while satisfying the requirements for switching data packets between the Access Points in a multi-point configuration.

### CROSS-REFERENCE TO RELATED APPLICATION

This application claims the priority benefit of provisional U.S. application serial No. 60/287,501, filed Apr. 30, 2001, of the same title, by the same inventors and assigned to a common owner. The contents of that priority application are incorporated herein by reference.

### BACKGROUND OF THE INVENTION

1. Field of the Invention

The present invention relates to communications network switching and, in particular, to switching between remote access points in a wireless local area network.

2. Description of the Prior Art

In order to support multiple remote nodes (e.g. wireless Access Points) on a single port in a central switching device, there must be a method of identifying each of the remote nodes and retransmitting the received data packet from the central node to the destination node. The retransmission is out of the same port in the central node from which the packet was received.

This function was previously performed by software running in a local processor in the central node. The wireless network connection used a single wireless port where each data packet received was processed by software and then retransmitted as a new data packet back out the same wireless port from which it was received.

Packet processing involves several steps:

a) Packet reception from a remote source node;

b) Identification of the remote source node from a unique field (e.g. a Logical Port Number) in the received frame header;

c) Identification of the remote destination node from the received packet's Media Access Control (MAC) address;

d) Modification of the Logical Port Number to that of the remote destination node;

e) Transmission of the packet out the same port in the central node from which it was received.

Among the disadvantages of this approach are that the software switching method does not scale well to higher speed wired and wireless LANs. In order to keep up with higher speed networks the processor performance burden is increased to the point where a cost effective, competitive solution is difficult. Therefore, what is needed is a system and related method to achieve line rate packet forwarding in a multi-point wireless LAN. What is also needed is such a system and method to provide switching of packets between multiple remote nodes independent of the network protocol used in the packets. Further, what is needed is to provide a means of uniquely identifying each of the remote nodes and modifying the appropriate fields within a frame to retransmit the data packet from the central node back to the correct destination remote node. Yet further, what is needed is a means of switching a data packet from a separate wired or wireless port to or from the port acting as the multi-point port in the central node of a multi-point network. Also, what is needed is a means of automatically replicating multicast packets destined for a remote wireless Access Point in a multi-point configuration without processor intervention.

### SUMMARY OF THE INVENTION

An object of the present invention is to achieve line rate packet forwarding in a multi-point wireless LAN. Another object of the invention is to provide switching of packets between multiple remote nodes independent of the network protocol used in the packets. A further object of the present invention is to provide a means of uniquely identifying each of the remote nodes and modifying the appropriate fields within a frame to retransmit the data packet from the central node back to the correct destination remote node. Yet another object is to provide a means of switching a data packet from a separate wired or wireless port to or from the port acting as the multi-point port in the central node of a multi-point network. Still further, it is an object of the present invention to provide a means of automatically replicating multicast packets destined for a remote wireless Access Point in a multi-point configuration without processor intervention.

These and other objects are achieved in the present invention by removing the processor from the packet switching data path and using a dedicated hardware device to make packet switching decisions. This device can operate at full line rate independent of the processor. By using a commercially available, commodity Ethernet switch engine the cost trend follows the technology curve towards less expensive, and more feature rich parts.

The present invention provides data packet switching based on the MAC address that is done in hardware at full line speed. By using the Data Link Layer or Layer 2 MAC address to make the switching decision, the result is independent of the network protocol used in the packet.

Remote node identification is done in hardware based on an identifier field in the received data packet. The presence of the identifier field is predefined as part of a particular data packet format and the invention makes use of that existing field. The remote node identifier field in the received packet is used to select a specific corresponding physical port in a hardware switch engine. This method of using a one-to-one correspondence between remote logical ports and a local switch engine's physical ports takes advantage of several properties of common Ethernet switch engines. This scheme solves the problem of retransmitting a data packet back out the same port from which it was received while being able to learn and associate a MAC destination address with a unique remote wireless node. In normal operation, an Ethernet switch engine will not transmit a data packet back out the same port from which it was received. Instead, it will always be filtered. The present invention overcomes this ordinary operation by uniquely identifying each of the remote nodes and modifying the appropriate fields within a frame to retransmit the data packet from the central node back to the correct destination remote node.

The present invention further provides for the aggregation of multiple physical ports on an Ethernet hardware switch engine to achieve line rate packet forwarding in a multi-point wireless LAN. Line rate performance is more difficult at higher network data rates. While the preferred embodiment of the invention is directed to higher speed networks such as 100 Mbps wired Ethernet to 11 Mbps and 54 Mbps wireless links, it will scale well to other speed networks with the appropriate hardware switch support.

The multiple Ethernet physical ports are aggregated into a single physical wireless port and are therefore treated as if they were a single logical Ethernet port for the purpose of switching packets. That is, the invention provides a means of switching a data packet from a separate wired or wireless port to or from the port acting as the multi-point port in the central node of a multi-point network.

Further, the invention provides a means of automatically replicating multicast packets destined for a remote wireless Access Point in a multi-point configuration without processor intervention. The methods of the invention may also be applied to any configuration where multiple, independent logical ports are interconnected via a single logical port on a hardware switch engine.

These and other advantages of the present invention will become apparent upon review of the following detailed description of the preferred embodiment, the accompanying drawings, and the appended claims.

### BRIEF DESCRIPTION OF THE DRAWINGS

FIG. 1 is a simplified block diagram of a network switching system for wireless access points including the conversion and translation logic device of the present invention.

FIG. 2, comprised of connected FIGS. 2A-2C, is a simplified flow diagram of the signal receive process flow of the present invention.

FIG. 3 is a simplified flow diagram of the signal transmit process flow of the present invention.

FIG. 4 is a simplified illustration of a multipoint wireless network access configuration including the conversion and translation logic device of the present invention.

### DETAILED DESCRIPTION OF THE PREFERRED EMBODIMENT OF THE INVENTION

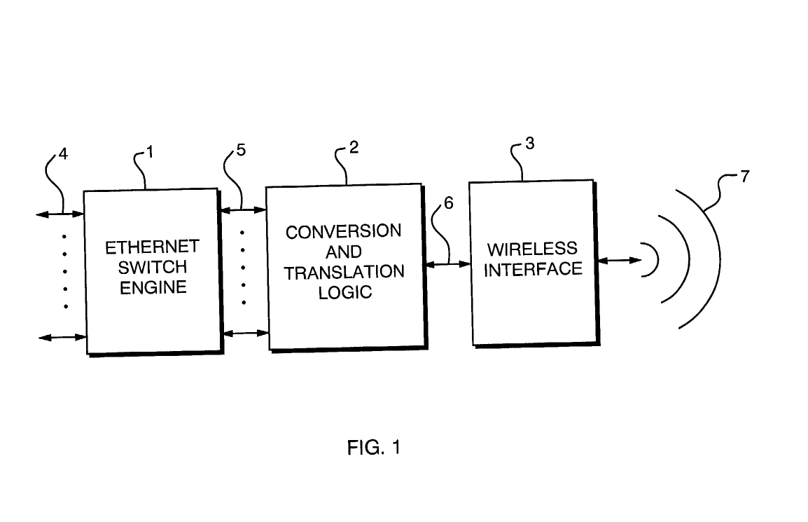

A simplified representation of the present invention is shown in FIG. 1. The system of the invention includes in combination a switch engine 1 and a logic block 2. The logic block 2 acts as an interface between the switch engine 1 and a wireless interface device 3 used to exchange data signals with network-accessing intermediate or endpoint devices by way of wireless (radio or infrared) connections. Arrows 4 represent one or more physical or logical ports used to connect the switch engine 1 to one or more backbones, networks, subnetworks, endpoint devices, or combinations thereof. Arrows 5 represent a plurality of physical ports establishing the interconnection between the switch engine 1 and the logic block 2. The physical ports are part of a physical wired connection between the switch engine 1 and the conversion block 2. It is to be understood that, for the purposes of the present invention, a wired connection can be a metal or fiber optic connection. Arrow 6 represents an interface connection between the logic block 2 and the wireless interface device 3. That interface connection 6 is a single physical connection representative of signal exchange in a wireless environment. The final connection is established between the wireless interface device 3 and devices exchanging signals with the wireless interface device 3 by way of a wireless connector 7 such as a radio and its antenna. The connector 7 may be an integral part of device 3 or separate from but connected thereto.

The switch engine 1 may be a common, multi-port protocol-based hardware switch engine including, but not limited to an Ethernet switch, used to provide basic switching functionality including MAC address learning, forwarding and filtering decisions and network access control. A suitable switching engine is the Galnet 3 family of switching chips available from Galileo Technology Ltd. of Israel but is not limited thereto. The block 2 is configured to convert between dissimilar packet formats associated with the switch engine and a wireless network. This functionality is preferably provided in hardware in order to reach maximum line rate performance at a reasonable cost, particularly as the speeds of wireless links increase. This block 2 is also responsible for controlling the use of the multiple interfaces 5 to the switch engine 1. This is done by detecting the unique remote node identifier in packets received from the wireless interface 3 and then sending that packet into the switch engine 1 on the corresponding physical interface 5. Packets arriving from another interface through the switch engine 1 are received into the block 2 on a specific one of the physical port interfaces 5, according to the packet's MAC destination address. The block 2 will use the physical port information to insert a logical port number into the wireless packet header before passing that packet to the wireless interface 3 for transmission. In the preferred embodiment of the invention, block 2 is a Field Programmable Gate Array (FPGA). The FPGA that is block 2 contains interface logic and state machines for each of the attached ports from the switch engine 1, as well as logic to extract or insert a remote access point identifier number. It also contains the necessary conversion logic and state machines for converting to and from the selected packet formats (e.g., Ethernet and 802.11 wireless packet formats). It further contains a PCMCIA or CardBus interface to the wireless interface device 3 as well as miscellaneous logic and control registers as required by the particular application.

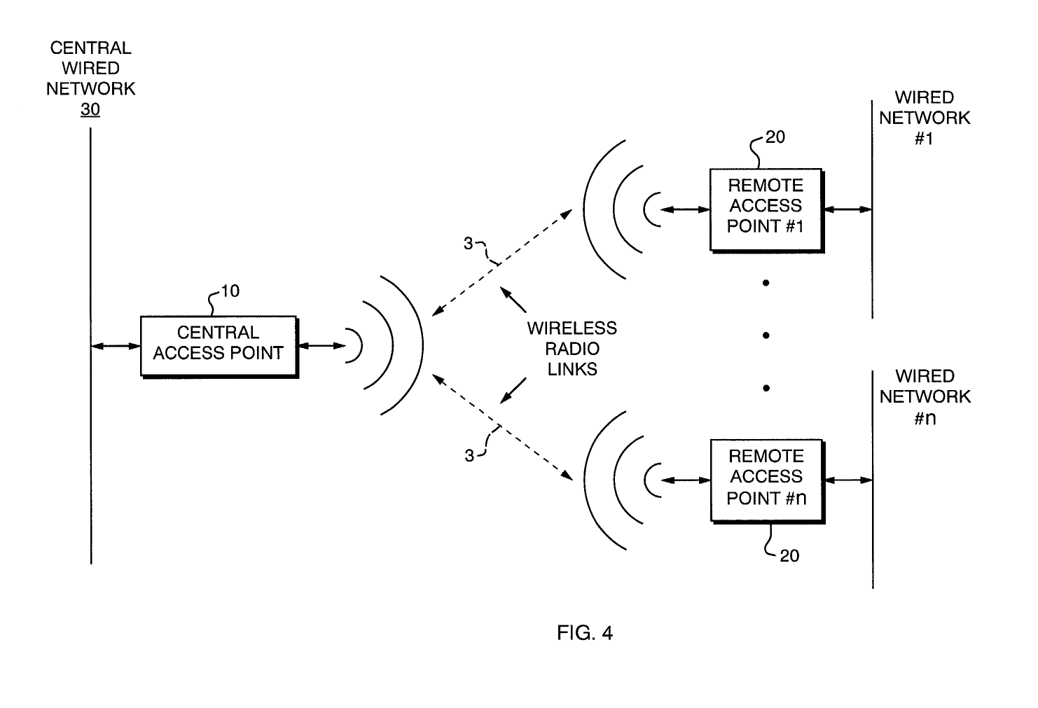

With continuing reference to FIG. 1 and with reference to FIG. 4, the wireless interface 3 can be any system that supports multiple remote Access Points, usually for LAN-to-LAN applications. An example would be wireless interfaces that follow the IEEE 802.11 standards. An example configuration of the present invention embodying the components shown in block form in FIG. 1 is shown in FIG. 4. A Central Access Point 10 is the relay engine including components 1 to 7 of FIG. 1 for exchanging signals between one or more Remote Access Points 20 and/or between Remote Access Points 20 and a network represented as a central network 30. Data packets going from one Remote Access Point 20 to another Remote Access Point 20 must pass through the Central Access Point 10, and any attempt to access the central network 30 must also pass through the Central Access Point 10.

The switch engine 1 can have multiple ports that are attached to other wired or wireless networks. These ports are independent of the wireless port described in this invention and they are included to provide access to a backbone or other networks, as shown in FIG. 4. As described, the group of physical ports 5 from the switch engine 1 is connected to the block 2. The number of ports is greater than one and can be any number depending on the number of remote wireless Access Points that are being supported. Although there are multiple physical ports in this grouping they are aggregated together into a single logical port. That is, any packets passing across this interface are considered to be associated with the single wireless interface 3. Thus, the multiple physical ports represented by arrows 5 are considered as a single logical port for address learning and switching decisions. In this way, the present invention enables point to multi-point exchange in a wireless environment. The interface to the wireless interface 3 can be any generic interface that supports the desired wireless interface 3. This could be a standard bus interface such as CardBus or PCMCIA or a proprietary interface.

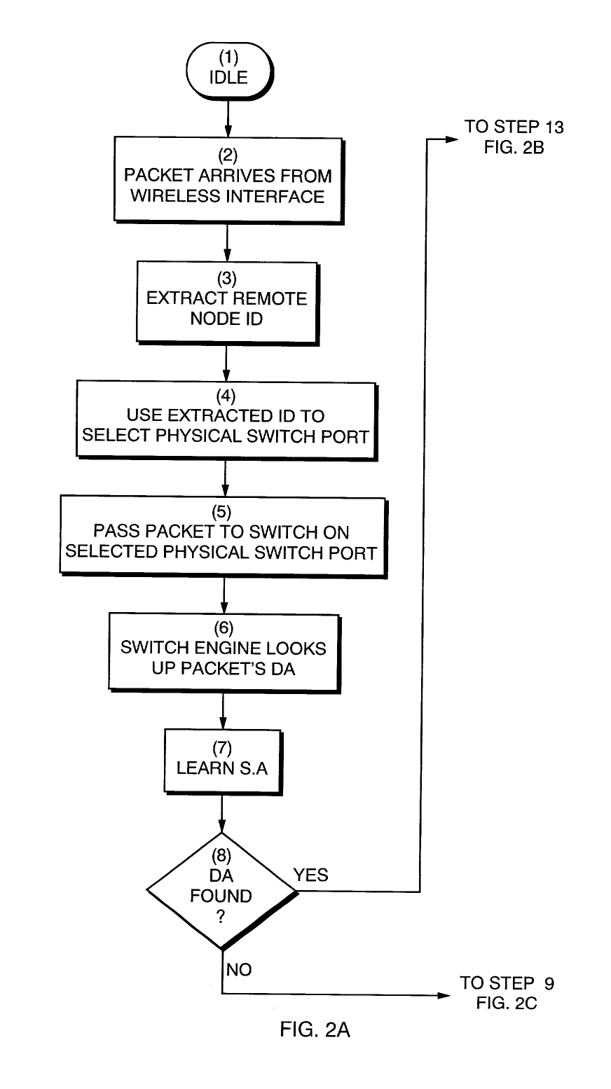

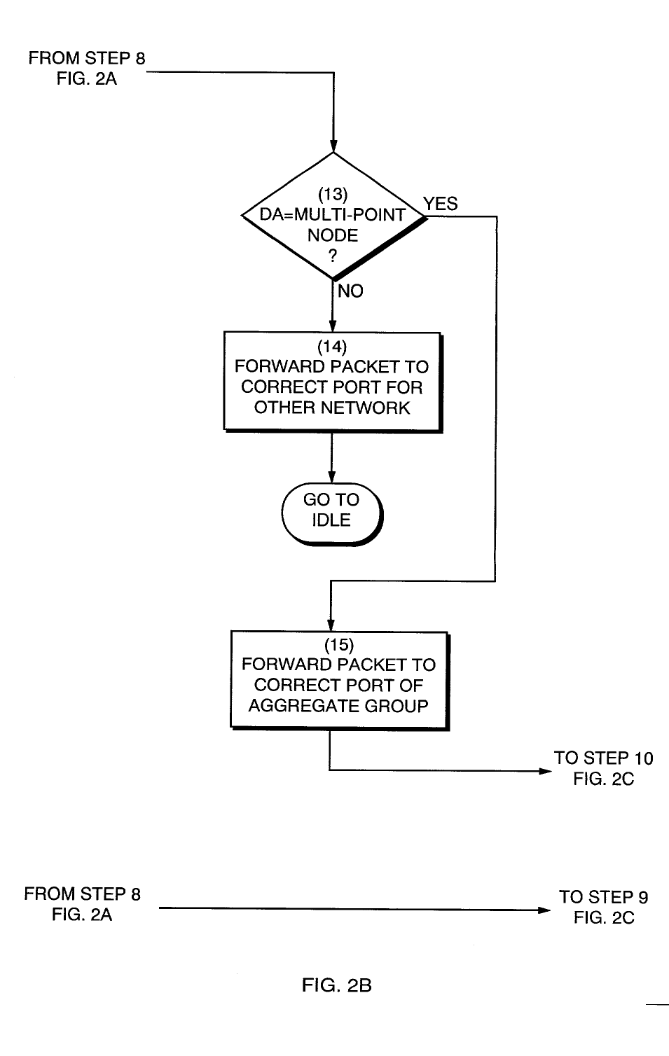

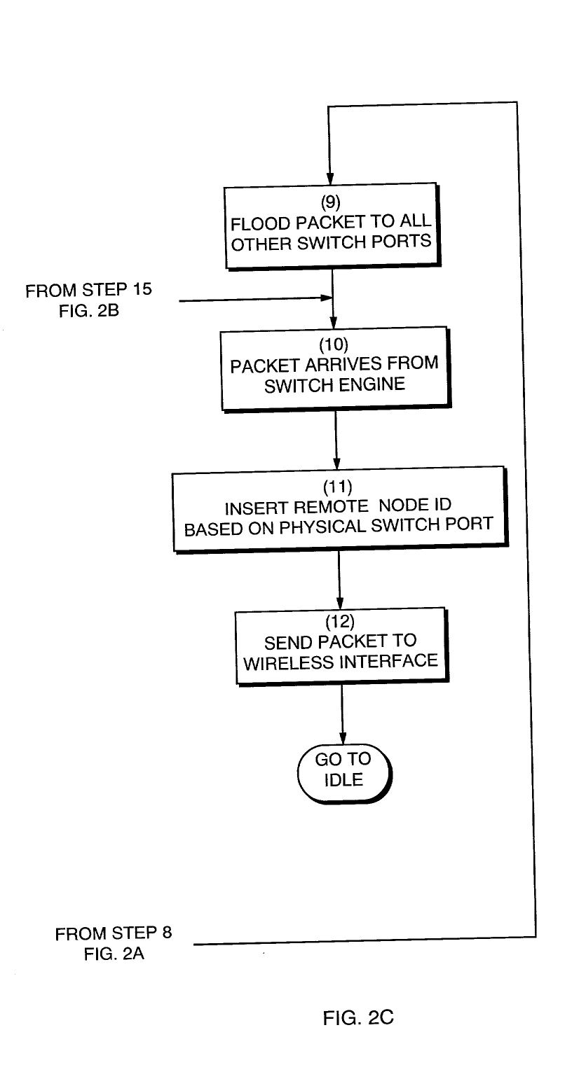

FIG. 2 (FIGS. 2A-2C inclusive) illustrates the process flow associated with signal reception through the Central Access Point 10 including block 2 of the present invention. In particular, the receive process is defined as the processing of data packets received from the wireless interface 3. The processing could also include packet format conversion. The received packets are destined for either another network via a different switch port or a different wireless Remote Access Point or both. The descriptions are keyed to the numbered boxes in FIGS. 2A-2C (Receive Process Flow).

Box 1: The IDLE state represents inactivity. There are no packets to process at this time.

Box 2: A data packet arriving from the radio through the wireless interface 3 will start the process flow. It is assumed that this packet has been checked for errors in the wireless interface 3.

Box 3: Once the packet has been received into the conversion block 2 the remote Access Point ID will be extracted from the appropriate field in the packet's header. The ID will be a number from 1 to “n” where “n” corresponds to the total number of Remote Access Points 20 being supported.

Box 4: The remote Access Point ID extracted from the received packet is used to direct the packet to a specific physical interface 5 to the switch engine 1. There is a permanent, fixed correspondence between the remote Access Point ID and a particular one of the physical switch interfaces 5. For example, a data packet received with a remote Access Point ID of 3 would always be directed to switch engine interface 3.

Box 5: The packet is then passed to the switch engine 1 across the appropriate interface. This insures that each of the Remote Access Points 20 will have its own physical interface to the switch engine 1. This is important when the switch engine 1 learns a Source Address (SA) or looks up a Destination Address (DA).

Box 6: The switch engine 1 will perform a standard DA lookup in order to make a forwarding decision. The result of this lookup will either return the switch engine port on which that DA resides or return an “Address Not Found” status.

Box 7: The switch engine 1 will also lookup the SA of the received packet to see if it has already learned this address. If the SA was not found in the address table the switch engine 1 will enter the packet's SA into the address table. This is the standard IEEE 802.3 bridge learning function. In this case the SA corresponds to a node on a network reached through a specific Remote Access Point. The switch engine 1 has now associated a specific Remote Access Point with a specific switch port. This is true because the actions in Box 4 insured that packets from one and only one specific Remote Access Point can enter the switch engine 1 over a particular port interface.

Box 8: The decision made at this point determines how the switch engine 1 will handle this packet. The further processing action is determined by the result of the DA lookup in Box 6.

Box 9: If the DA was not found in the switch engine address table then the switch engine 1 does not know which forwarding port should get this packet for transmission. The standard procedure in Ethernet switches is to then forward a copy of this packet, also called flooding, to each active port on the switch engine 1 except the port from which the packet was received. This same procedure is also performed on multicast packets. Multicast packets have a special DA that bypasses the lookup step and is automatically flooded to all ports except the one from which it was received. This invention relies on the switch engine 1 to automatically replicate a flooded packet to each of the active ports.

Box 10: At this point a packet has arrived at the conversion logic block 2 from the switch engine 1 for one of two reasons. The packet has either been flooded because of an unknown or multicast DA or the packet has come back to the block 2 because it was originally received from a wireless Remote Access Point 20 and its destination is a node on another wireless Remote Access Point 20 in the same multi-point configuration.

Box 11: The block 2 then inserts the unique remote Access Point ID in the frame header. The value of the ID is derived from the physical port from which the packet was received from the switch engine 1. For example, if the packet arrived over switch engine interface 5 then the destination remote node ID would be 5. This maintains the fixed relationship between the logical remote Access Point ID and the specific physical interface to the switch engine 1.

Box 12: Once the frame has the proper ID value and any necessary packet conversion has been completed it is transferred to the wireless interface 3 for transmission. The process flow then returns to the IDLE state.

Box 13: If the DA lookup in Box 8 was successful and the DA was found in the address table a further decision is made. If the DA indicates a port that is not part of the aggregate port group to the conversion block 2 then the packet is destined for one of the independent network ports 4 on the switch engine 1. If the DA indicates a port that is one of the aggregated ports then this packet will be sent back to the conversion block 2 in preparation for wireless transmission. Note that during this decision process the common switch engine 1 does not require knowledge of the wireless interface 3 nor the special grouping of ports 5 to the logic block 2. The forwarding decision process is a standard process; however, the use of the port grouping via the block 2 as provided by the present invention enables that in a wireless environment.

Box 14: If the DA lookup returned a switch port that was not part of the special grouping then the packet is forwarded to the indicated port and is queued for normal transmission. The process flow then returns to the IDLE state.

Box 15: If the DA lookup returned a switch port that was part of the special port grouping then the packet would still be forwarded as a normal switched packet. The switch engine 1 has no knowledge of the special grouping. The only difference between Box 14 and Box 15 is that Box 15 results in the packet going to the wireless conversion logic block 2. The packet will be passed to the conversion logic block 2 over the specific interface associated with that particular DA. This association was provided earlier when that address was learned in the address table. Processing will now continue with Box 10 and proceed as described earlier.

In summary, the receive process includes the following steps:

a) A data packet arrives from a wireless Remote Access Point 20 with a unique identifying number in the frame header.

b) The unique ID is directly associated with a specific port on the common switch engine 1.

c) When the packet enters the switch engine 1, the normal address lookup causes the packet to be looped back to the wireless conversion logic block 2. The packet loopback happens over a different physical interface from which it was sent to the switch engine 1. This is necessary because the common switch engine is not configured to send a packet back out the same port from which it was received.

d) The conversion logic block 2 uses the specific physical port number to determine the correct logical remote node ID to insert into the wireless packet frame header.

e) By taking advantage of the standard address learning process in a common Ethernet switch engine this invention uses physical port aggregation to differentiate remote wireless Access Points. This is done by associating each physical port on the switch engine 1 with one and only one remote wireless Access Point.

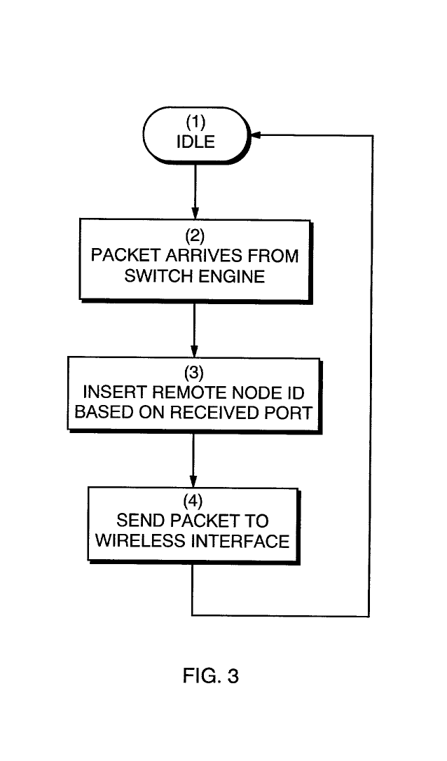

The transmission of signals from the Central Access Point 10 of the present invention is a bit simpler and is considered in view of FIG. 3. The transmit process is defined as the processing of data packets received from the switch engine 1 that originated on a switch engine port not associated with the wireless interface 3. In other words, these packets are simply forwarded through the wireless interface 3. They are not looped back from one remote wireless Access Point to another remote wireless Access Point as in the receive process described previously. It is to be understood that the processing could also include packet format conversion. Transmit packets are destined for one of the remote wireless Access Points. The descriptions are keyed to the numbered boxes in FIG. 3 as described herein.

Box 1: The IDLE state represents inactivity. There are no packets to process at this time.

Box 2: The packet arrives at the conversion block 2 over a specific physical interface from the switch engine 1. The specific interface corresponds to the specific remote Access Point for which the packet is destined.

Box 3: The conversion logic block 2 inserts the unique remote Access Point ID in the frame header. The value of the ID is derived from the physical port from which the packet was received from the switch engine 1. For example, if the packet arrived over switch engine interface 5 then the destination remote node ID would be 5. This maintains the fixed relationship between the logical remote Access Point ID and the specific physical interface to the switch engine 1.

Box 4: Once the frame has the proper ID value and any necessary packet conversion has been completed, it is transferred to the wireless interface for transmission. The process flow then returns to the IDLE state.

The system and method of the present invention provide improvements in the exchange of electronic signals between wireless devices and between wireless and wired devices. In particular, the present invention is configured to establish the use of multiple physical ports on switching engine, such as an Ethernet-configured switch, where each physical port is mapped to one, and only one, remote logical port. In turn, the multiple physical ports are aggregated into a single logical port for switching decisions concerning the wireless interface. This allows the switch engine to perform normal packet processing for forwarding and filtering decisions while maintaining the unique identity of the remote wireless Access Points necessary in a multi-point configuration.

The arrangement of the present invention provides a method of using a commonly available hardware switching engine to facilitate switching data packets between remote wireless nodes in a multi-point configuration; however, it overcomes a basic problem in common Ethernet switching engines, in which they will not forward a packet back out to the same port from which such a packet was received. In addition, by basing the switching decision solely on the packet's MAC DA the decision is independent of the network protocol being used. In doing so, the present invention can aggregate multiple physical interfaces into a single logical port to the wireless interface for switching, filtering and learning functions.

Those skilled in the art will recognize that the hardware switch engine 1 may be any commercially available type, such as the Galnet 3 switch chip family from Galileo Technology Ltd. suitable for multiport switching. Alternatively, the switch engine 1 could be a custom Application Specific Integrated Circuit (ASIC) or Field Programmable Gate Array (FPGA) rather than a commercially available part. Further, the conversion and translation logic block 2 could be built into a custom ASIC that includes the switch engine 1 or be a stand-alone device. The conversion and translation logic block 2 could be implemented in software running in a fast local processor. However, it is to be understood that a complete software solution for point-to-multipoint exchange with a fast processor would be a less practical solution due to the cost of a fast processor and its associated support memory. A software-based solution is even less likely if the device must support higher network data rates, such as 100 Mbps wired Ethernet or 54 Mbps wireless radio links.

The present invention provides high performance at low cost. The use of commercially available switching engines for a Point to Multi-Point Wireless Access Point application in combination with the translation and logic block provides for more performance and functionality than existing implementations, which were software based and limited by the performance of the processor, memory and Input/Output subsystems. This invention is applicable in any wireless access points that use switch chips, regardless of protocol.

While the present invention has been described with specific reference to a particular embodiment, it is not limited thereto. Instead, it is intended that all modifications and equivalents fall within the scope of the following claims.

What is claimed is:

1. A system to enable electronic signal exchange in a multipoint wireless network including a plurality of remote wireless access points, the system including a central wireless access point having:
a. a switch engine with multiple physical communication interfaces; and
b. a conversion block having multiple physical communication interfaces for wired connection to one or more of the multiple physical communication interfaces of the switch engine, and a wireless signal exchange interface for communicating with the remote wireless access points, wherein the conversion block is configured to associate each unique identifier corresponding to a remote wireless access point with one and only one of the physical communication interfaces of the switch engine.

2. The system as claimed in claim 1 wherein the conversion block is further configured to aggregate the multiple physical communication interfaces thereof into a representation as a single logical communication interface for wireless signal exchange.

3. The system as claimed in claim 1 wherein the unique identifier of a remote wireless access point is a Media Access Controller (MAC) address and the association is a unique number corresponding to a physical communication interface number.

4. The system as claimed in claim 1 wherein the association of the unique identifier with a physical communication interface of the switch engine is independent of any protocol associated with the electronic signal exchange.

5. The system as claimed in claim 1 wherein the switch engine and the conversion block are embodied in a single Application Specific Integrated Circuit.

6. A method to enable the exchange of electronic signals by one or more remote wireless access points in a wireless network system including a central wireless access point in communication with the one or more remote wireless access points, wherein the central access point includes a single wireless communication interface and a plurality of physical communication interfaces, the method comprising the steps of:
a. receiving at the wireless communication interface of the central access point a data packet from a remote wireless access point;
b. extracting from the data packet a unique identifier associated with the remote access point;
c. associating the unique identifier with one and only one of the physical communication interfaces; and
d. directing all data packets having the unique identifier only to the one associated physical communication interface.

7. The method as claimed in claim 6 wherein the central access point includes an address table having destination address information and source address information, the method further comprising the steps of:
a. examining the received data packet for packet destination address and packet source address;
b. acknowledging the existence or absence of the packet destination address in the address table; and
c. acknowledging or entering the packet source address in the address table.

8. The method as claimed in claim 7 further comprising the step of associating the packet source address with a specific physical communication interface.

9. The method as claimed in claim 8 further comprising the step of flooding the packet back to all of the physical communication interfaces except the one associated with the packet's source address when the packet destination address does not exist in the address table of the central access point.

10. The method as claimed in claim 9 wherein when a data packet having a destination address that is not in the address table is received at one of the physical communication interfaces, the method further includes the steps of inserting into a frame header of the data packet a unique remote access point identifier corresponding to the physical communication interface at which the data packet was received and transmitting the data packet with the inserted unique remote access point identifier to a remote access point associated with that unique remote access point identifier.

11. The method as claimed in claim 10 wherein the one of the physical communication interfaces is a physical switch port and the unique remote access point identifier is the switch port number.

12. The method as claimed in claim 6 wherein the central access point includes a conversion logic block.

13. The method as claimed in claim 6 wherein the central access point includes a network switch engine.

14. The method as claimed in claim 6 wherein the step of associating the unique identifier with one and only one of the physical connection interfaces is independent of the protocol associated with the transfer of the data packet.

15. A method to enable the transmission of electronic signals to one or more remote wireless access points in a wireless network system including a central wireless access point in communication with the one or more remote wireless access points, wherein the central access point includes a single wireless communication interface and a plurality of physical communication interfaces, the method comprising the steps of:
a. receiving at one of the physical communication interfaces a data packet including a destination address;
b. inserting into a frame header of the data packet a unique remote access point identifier corresponding only to the one of the physical communication interfaces at which the data packet was received; and
c. transmitting the data packet with the unique remote access point identifier to the specified remote wireless access point.

16. The method as claimed in claim 15 wherein the central access point includes a switch engine and the physical communication interfaces are switch ports.

17. The method as claimed in claim 16 wherein the unique remote access point identifier corresponds to the switch port number.
